(19) United States
(12) Patent Application Publication
(10) Pub. No.: US 2014/0301072 A1
(43) Pub. Date: Oct. 9, 2014

(54) LIGHTING FIXTURES HAVING ILLUMINATED ORNAMENTS AND METHODS FOR PROVIDING ILLUMINATION

(71) Applicant: SWAROVSKI LIGHTING, LTD., Plattsburg, NY (US)

(72) Inventors: Saewoo PARK, Plattsburgh, NY (US); James L. Pettingill, Essex Junction, VT (US)

(73) Assignee: Swarovski Lighting, Ltd., Plattsburg, NY (US)

(21) Appl. No.: 13/857,838

(22) Filed: Apr. 5, 2013

(51) Int. Cl. F21V 33/00

(52) U.S. Cl. CPC F21V 33/0028
USPC 362/235

(57) ABSTRACT

A lighting fixture includes a support having an outer surface and at least one inner surface defining at least a portion of a passageway extending through said support, a plurality of ornaments disposed inside said passageway, and at least one of a light source and a receptacle for a light source for emitting light into said passageway and onto some of said plurality of ornaments which emitted light is at least one of refracted and reflected from said plurality of ornaments through said at least one inner surface and out said outer surface of said support.

### FIELD OF THE INVENTION

This present disclosure relates generally to lighting fixtures having illuminated ornaments and methods for providing illumination.

### BACKGROUND OF THE INVENTION

Recently, solid state lighting fixtures or LED light fixtures are becoming more popular. One such LED fixture generally includes a LED module having a plurality of LEDs attached thereto for directing light inwardly toward an edge of an optical panel or light guide. A frame surrounds the optical panel and LED module, and includes on opening from which light emitted into the end of the panel is emitted from a first surface of the panel and through the opening in the frame.

Frost by Vincent Van Duysen is a light beam encrusted with crystals. The light beam can be supported on a table or suspended from above. The entire surface of the light beam includes a “crust” of randomly assorted, different sized crystals set into resin. Sandwiched between the crystal exteriors is a thin glass panel which gives the beams their structure and rigidity while also acting as a vehicle for the LED lighting within.

There is a need for further lighting fixtures having illuminated ornaments and methods for providing illumination.

### SUMMARY OF THE INVENTION

In a first aspect, the present disclosure provides a lighting fixture which includes a support having an outer surface and at least one inner surface defining at least a portion of a passageway extending through said support, a plurality of ornaments disposed inside said passageway, and at least one of a light source and a receptacle for a light source for emitting light into said passageway and onto some of said plurality of ornaments which emitted light is at least one of refracted and reflected from said plurality of ornaments through said at least one inner surface and out said outer surface of said support.

In a second aspect, the present disclosure provides a lighting fixture which includes a generally transparent support having an outer surface and a plurality of inner surfaces defining a plurality of passageways extending through said support, a plurality of crystals disposed inside said plurality of passageways, and at least one light source and a receptacle for a light source for emitting light into said plurality of spaced-apart passageways and onto some of said plurality of ornaments which emitted light is at least one of refracted and reflected from said plurality of ornaments through said plurality of inner surfaces and out said outer surface.

In a third aspect, the present disclosure provides method for providing illumination. The method includes receiving light in at least one passageway extending through a support containing a plurality of ornaments, and emitting light from the plurality of ornaments through an inner surface defining the at least one passageway of the support and out an outer surface of the support.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a front perspective view of one embodiment of a lighting fixture in accordance with aspects of the present disclosure;

FIG. 2 is a rear perspective view of the lighting fixture of FIG. 1;

FIG. 3 is a front elevational view of the lighting fixture of FIG. 1;

FIG. 4 is a left side elevational view of the lighting fixture of FIG. 1;

FIG. 5 is a right side elevational view of the lighting fixture of FIG. 1;

FIG. 6 is a top view of the lighting fixture of FIG. 1;

FIG. 7 is a cross-sectional view taken along line 7-7 in FIG. 6;

FIG. 8 is a cross-sectional view taken along line 8-8 in FIG. 3;

FIG. 9 is a cross-sectional view taken along line 9-9 in FIG. 3;

FIG. 10 is an enlarged view taken along line 10-10 in FIG. 8;

FIG. 11 is an enlarged view of a portion of the view in FIG. 7; and

FIG. 12 is a flowchart illustrating a method for providing illumination in accordance with aspects of the present disclosure.

### DETAILED DESCRIPTION OF THE INVENTION

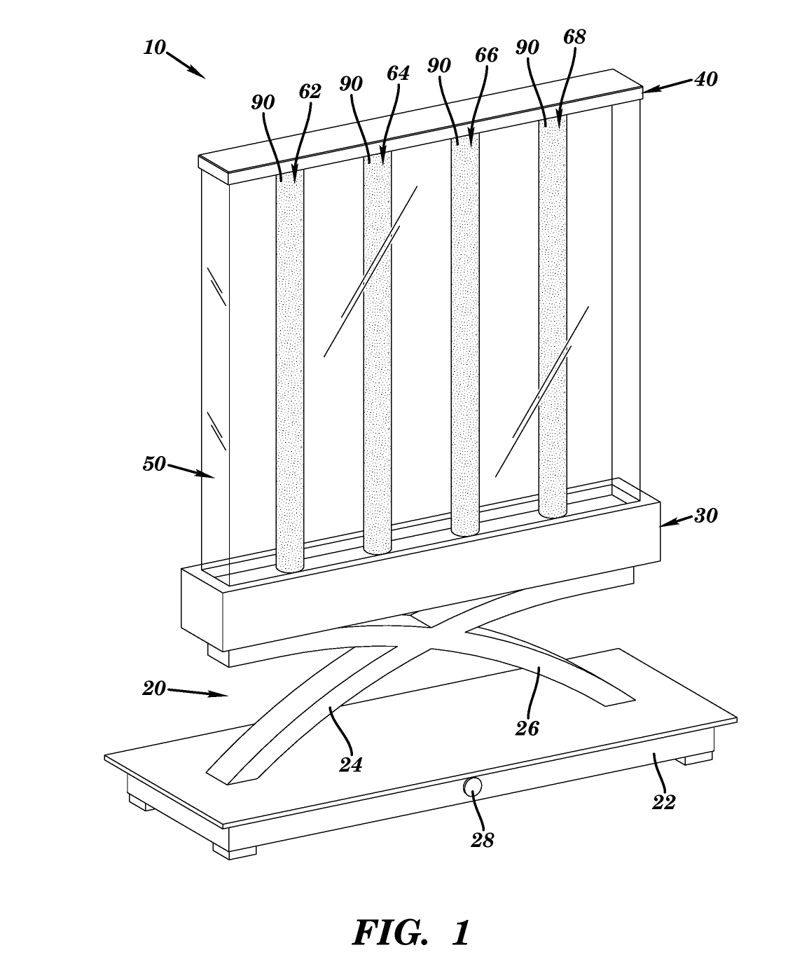

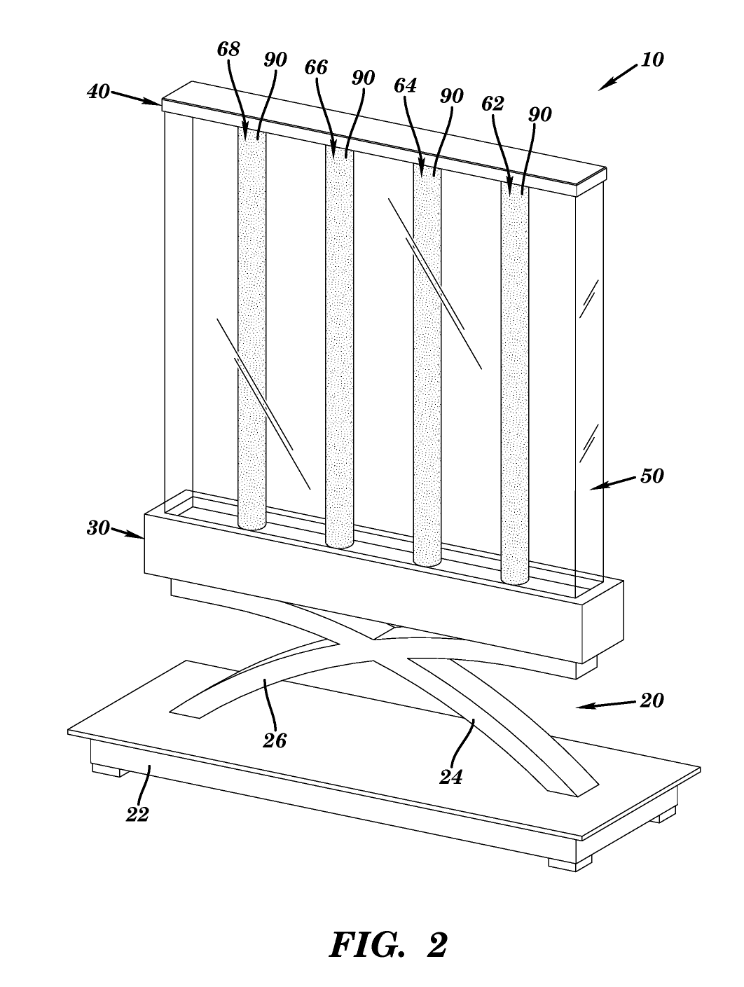

FIGS. 1-3 illustrate one embodiment of a lighting fixture 10 in accordance with aspects of the present disclosure. Lighting fixture 10 generally comprises a stand 20, a bottom frame 30, a top frame 40, and a support 50. In this illustrated embodiment, stand 20 may include a base 22 supportable on a table or other generally horizontal surface, and a plurality of crisscrossing arms 24 and 26. The lighting fixture is operably connected to a suitable electrical supply. A switch 28 (FIG. 1) may be disposed on the frame for turning on and off the lighting fixture. The switch may be a mechanical toggle or pushbutton switch. In addition to the switch or in place of the switch, a suitable motion sensor may be provided for automatically turning on and off to the lighting fixture. It will be appreciated that the stand and frame may have any suitable configuration for support of the light fixture on a table or other surface, suspended from a ceiling, supported from a wall, or supported in any suitable manner.

As described in greater detail below, support 50 includes one or more illuminated portions 62, 64, 66, and 68, which emit light from a plurality of ornaments 90.

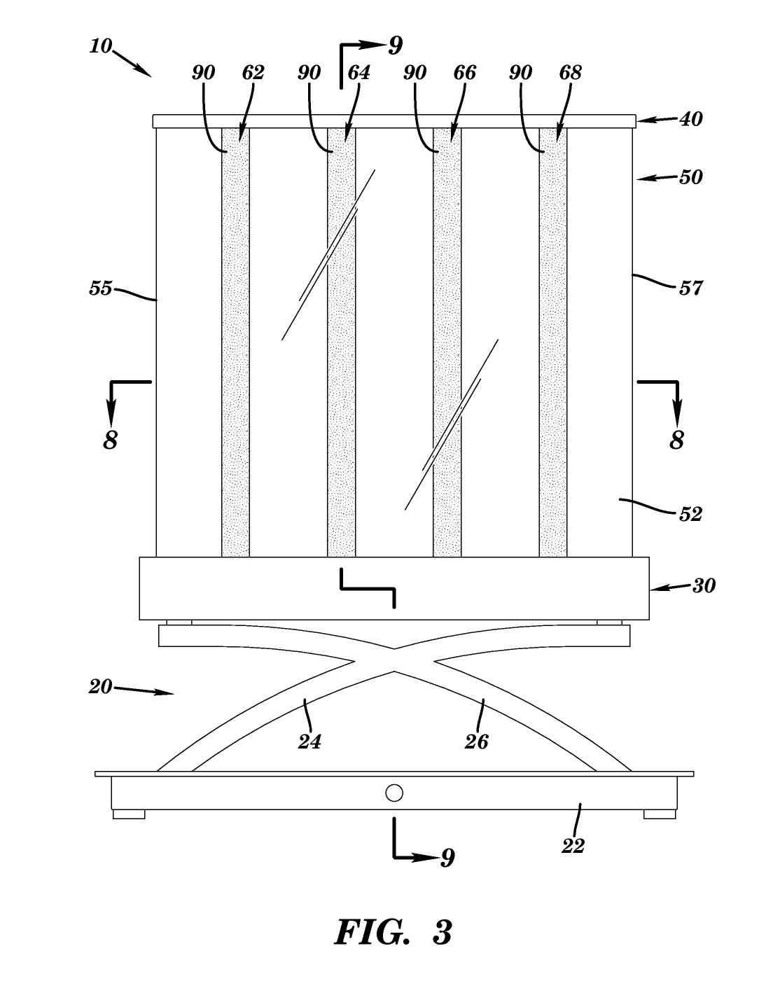

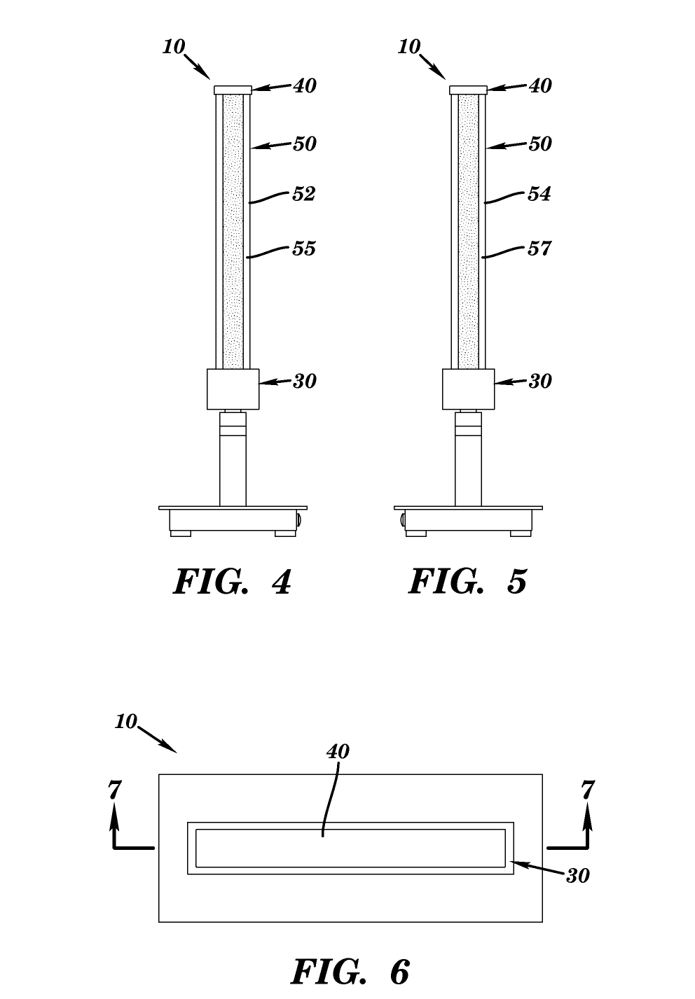

With reference to FIGS. 3-6, in this illustrated embodiment of lighting fixture 10, support 50 may be a planar member and the illuminated portions may comprise space-apart illuminatable portions. Support 50 may have a front surface 52 (FIG. 4) and a rear surface 54 (FIG. 5). Support 50 may have a generally constant thickness. Disposed between front surface 52 and rear surface 54 may be generally peripherally-extending side edges 55 and 57, and peripherally-extending top and bottom edges (not shown in FIGS. 3-5). The peripherally-extending edges may be disposed in a square configuration. It will be appreciated that the support may have any suitable configuration. For example, the support may be planar, have one or more curved sides and edges, and the peripheral edges may define a rectangular, circular, spherical, polygonal configurations, other suitable configurations, and combinations thereof. In one aspect, the support may be a planar support such as a plastic material or glass material, and may comprise a clear, translucent, or transparent material.

Bottom frame 30 and the top frame 40 may extend over portions of the peripherally-extending side edges, and the top and bottom peripherally-extending edges of support 50. One or more of the bottom and top frames may be formed from an opaque or non-translucent material. The stand, bottom frame, and top frame may be formed from a suitable material, such as metal or other material.

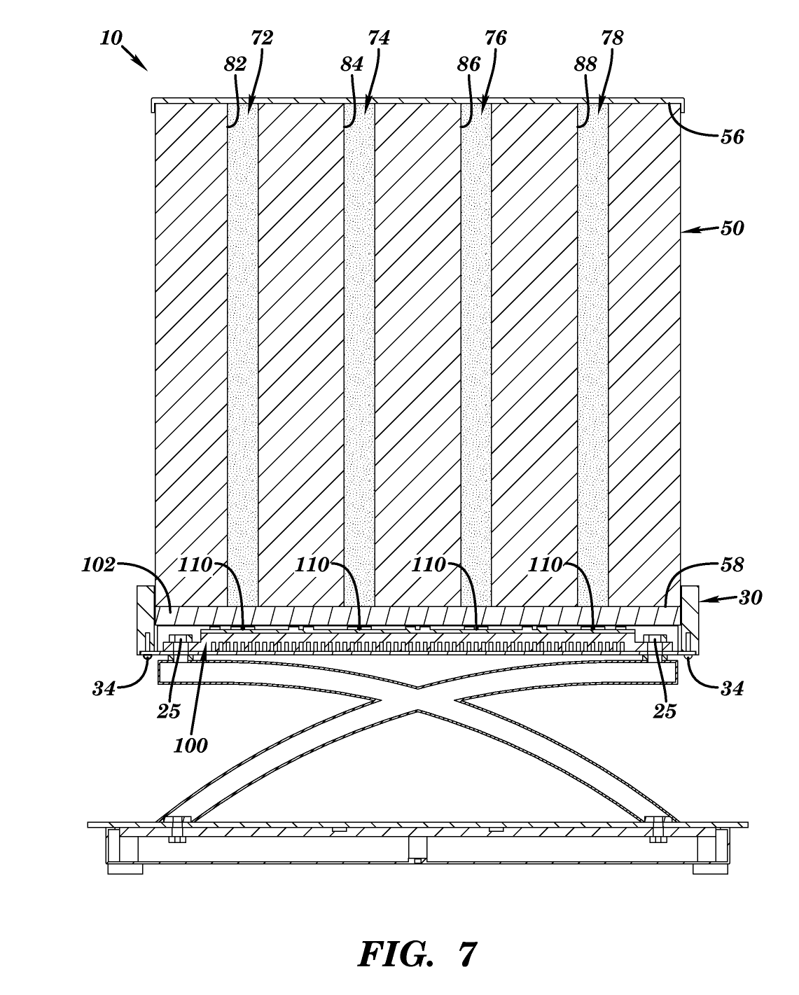

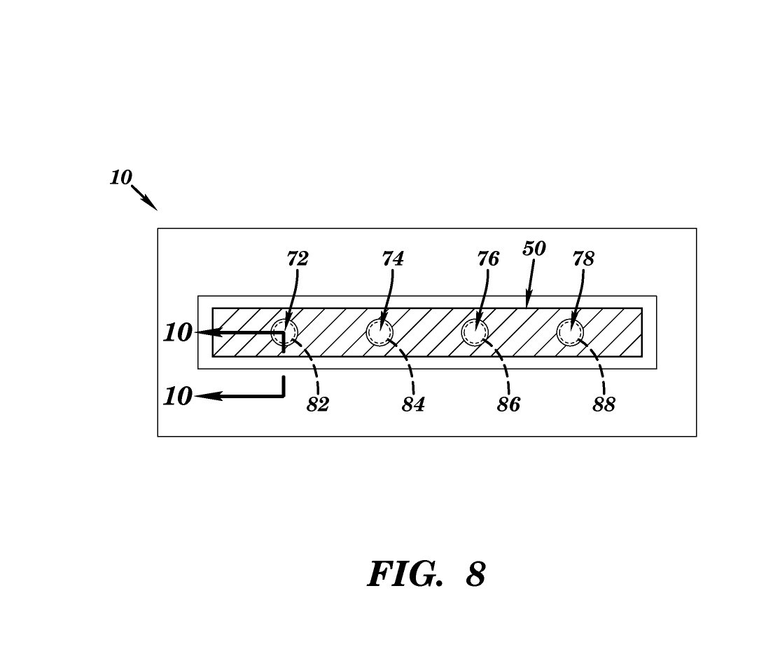

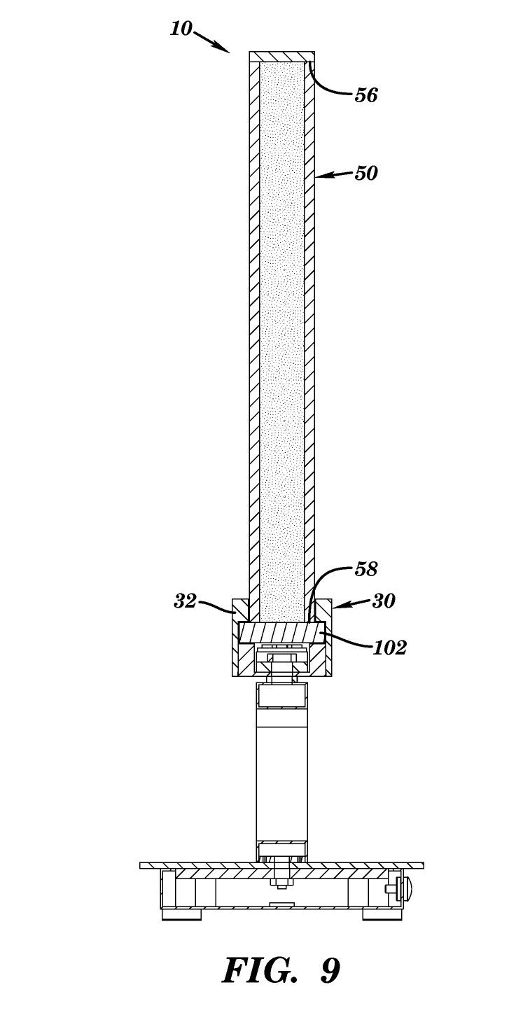

With reference to FIGS. 7 and 8, support 50 may include a plurality of spaced-apart passageways 72, 74, 76, and 78 extending through support 50. In this illustrated embodiment, the passageways may be spaced apart from the front and rear surfaces, and from the side edges of support 50. As best shown in FIGS. 7 and 9, in this illustrated embodiment, the passageways may open onto and extend between a top peripheral edge 56 and a bottom peripheral edge 58 of support 50. The passageways may have a round or circular cross-section as shown in FIG. 8, or may have other suitable configurations such as square, rectangular, oval, or other suitable cross-sectional configurations. Passageways 72, 74, 76, and 78 may be defined by respective inner surfaces 82, 84, 86, and 88. The passageways in the support may be formed by drilling holes through the support.

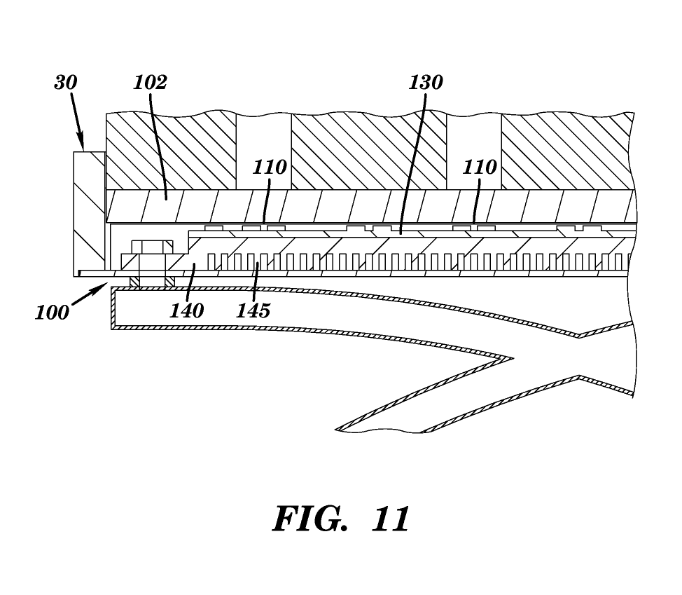

With reference again to FIG. 7, covered by bottom frame 30 is a light source 100. For example, as shown in FIGS. 7 and 11, light source 100 may be a LED (light emitting diode) module having a plurality of LEDs 110 disposed below the openings of passageways 72, 74, 76, and 78. The pluralities of LED may be disposed on a printed circuit board 130 and attached to a heat sink 140 (FIG. 11) having a plurality of heat exchange fins 145 (FIG. 11) to reduce the likelihood of the LEDs overheating. For example, the fins are operable to conduct heat from the LED module.

With reference to FIGS. 7 and 9, an elongate member 102 may be disposed between the bottom of support 50 and the plurality of LEDs 110. Elongated member 102 may be formed from glass, having the same length as the width of the support as shown in FIG. 7. The width of elongated member 102 may be wider than the thickness of the support as shown in FIG. 9. As shown in FIG. 9, elongated member 102 may be adhered or fused to support 50. Bottom frame 30 may have an enlarged end 32 which extends over side end portions of elongated member 102 to lock or retain support member to stand 20. For example, as shown in FIG. 7, a plurality of screws 25 may attach stand 20 to the LED module, and a plurality of screws may attach the LED module to bottom frame 30. The bottom frame may be open along the bottom, and bottom frame 30 may be spaced apart from the bottom sides of support 50 and elongated member 102 to allow circulation of air for cooling of the heat sink and LEDs. Top frame 40 may have an inner reflector or mirrored surface for reflecting light downwardly from the opposite end of the passageways.

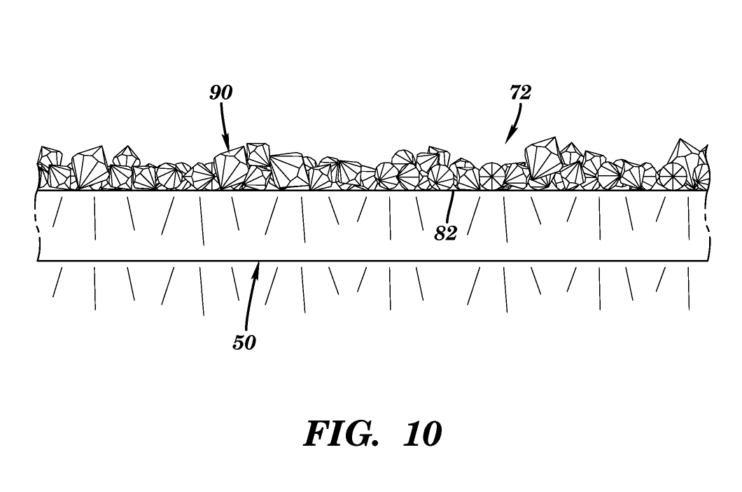

As best shown in FIG. 10, in this illustrated embodiment of the lighting fixture, a portion of illuminated portion 62 (FIG. 1) may include support 50 having passageway 72 defined by an inner surface 82 and the plurality of ornaments 90 disposed in passageway 72. In one embodiment, plurality of ornaments 90 may be attached to inner surface 82 of support 50. For example, the plurality of ornaments 90 may be attached to inner surface 82 with suitable glue, adhesive, or other bonding agent. For example, to attach the plurality of ornaments, a thin layer of glue is applied to the surface of the support, and the ornaments are then applied to the glue, for example, poured thereon. Some places may have one layer of ornaments, some may have two or more layers, depending on how the ornaments attach. Desirably, the adhesive or other bonding agent does not inhibit emission of light. With such a configuration, plurality of ornaments 90 may coat inner surface 82 of passageway 72 resulting in a hollow or vacant cavity in passageway 72. In other configurations, the entire passageway may be filled with the plurality of ornaments. In a similar manner, plurality of ornaments 90 may be disposed in passageways 74, 76, and 78.

According to aspects of the present disclosure, the ornaments may be any ornament, for example, an opaque, translucent, or transparent ornament or crystals. The ornaments may comprise a plastic, stone, metal, glass material, or may be gem stones, such as, rubies or sapphires. The translucent or transparent ornament may be comprise a tint or color, for example, blue or red, but may typically be substantially clear. In one aspect, the ornaments may be crystals provided by D. Swarovski Co. of Wattens, Austria, or their equivalent, and may be referred to as “bicone/chatons” crystals. Other suitable crystals Swarovski elements crystal bicone beads.

The plurality of ornaments 90 may of any available size, for example, from about 1 mm to about 100 mm in width or diameter, the plurality of ornaments 90 may typically comprise an average width or diameter less than or about 5 millimeters, less than or about 3 millimeters, less than or about 1 millimeter, and may range between about 2 and about 3 millimeters, between about 1 and about 5 millimeters, between about 3 and about 5 millimeters, or between about 1 and about 3 millimeters. It will be appreciated that other size ornaments may be suitably employed as well. The ornaments or crystals may be double-pointed stones, tetrahedrons, polyhedrons, or have other faceted configurations. The plurality of crystals may form a layer having a generally constant thickness.

The support may be a square planar support having a height and a width of about 3 feet, a height and a width of about 2 feet, a height and a width of a about 1 foot, or any suitable size and/or shape. Any suitable number of passageways having any suitable size and configuration may be employed. The passageways may extend from one edge of the support to another edge of the support or extend from and only onto only one edge. The ornaments disposed on the passageways may be generally the same, or the ornaments disposed in each of a plurality of passageways may be generally different, and/or combinations thereof.

In one embodiment, the support may be formed from a planar glass material having a height of about 11⅜ inches (about 289 millimeters), a thickness of about 1⅜ inches (about 35 millimeters). The four passageways may be formed by drilling holes such as from both sides having a diameter of about ¾ inch (about 18 millimeters). After drilling, the inside surface of the holes may be polished to have a smooth surface finish. Adhesive such as DYMAX 496 ultraviolet curable adhesive, available from Dymax Corporation of Torrington, Conn., is applied to the inner surface of the passageways, and the crystal brought into contact with the adhesive. The crystals may have an average diameter of about ⅛ inch (about 3 millimeters). The crystals may be Swarovski elements crystal bicone beads having a diameter of about 3 mm. The plurality of crystals may form a layer having a generally constant thickness of about 3 millimeters to about 4 millimeters.

With reference again to FIG. 1 and from the present disclosure, it will be appreciated that the plurality of passageways and plurality of ornaments act as light guides which are illuminated by the plurality of LEDs illuminating the inside of the plurality of passageways. For example, light from the plurality of LEDs may be directed from inside the passageways onto the plurality of ornaments which light is then generally reflected, refracted, and/or emitted by the plurality of ornaments outwardly through the inner surface and into the support and generally out the front surface or rear surface of the support.

Light fixture 10 may be illuminable so that to an observer light is being emitted primarily from the plurality of ornaments, which in this illustrated embodiment, appears as illuminated vertical stripes or columns whether viewed normal to the front or rear surface, or at an angle right or left, or up or down, from the front or rear surface. The portions of the support between the passageways are generally not illuminated and an observer is able to see through the portions between the passageways while being able to observe the illuminated ornaments. The light source may be or may not be observable to observers. In one aspect, the light may be diffused through the plurality of ornaments or crystals in the vertical passageways or chambers representative of illuminated candles.

The light source may be an LED or light emitting diode light source, incandescent, florescent, charged gas, or other suitable light sources, and combinations thereof. While the passageways in the described lighting are illustrated as being vertically extending passageways, the passageways disposed horizontally, for example, with the LEDs disposed along one or more vertical sides. In addition, the passageways need not extend the entire length or width of the support, and may be made to intersect or cross. The plurality of ornaments may cover the entire inner surface of the passageways or may extend over or cover only a portion of the inner surface of the passageways. The light sources may be disposed along any of the side portions of the support.

The support may be a monolithic structure or comprise a one-piece construction, or formed from several separate pieces. The passageways may be contained entirely within the support or may be open passageways such as open channels along one or more outer surfaces. The passageways may be formed between surfaces of two or more, for example, planar supports. In other embodiments, the support may comprise one or more spaced-apart tubes such as glass tubes having the crystals disposed in the tubes such as attached to the inner surface of the tube as described above. In another embodiment, a planer support having a plurality of passageways disposed therein may include a plurality of tubes such as a glass tube disposed in each of the passageways. The outer surface of the tubes may be spaced apart from the inner surface of the support, and a plurality of ornaments such as crystals disposed therein either loosely or bonded using an adhesive. In another embodiment, first plurality of tubes such as glass tubes may be disposed in a second plurality of tubes such as glass tubes. The outer surface of the inner tubes may be spaced apart from the inner surface of the outer tubes, and a plurality of ornaments such as crystals disposed therein either loosely or bonded using an adhesive.

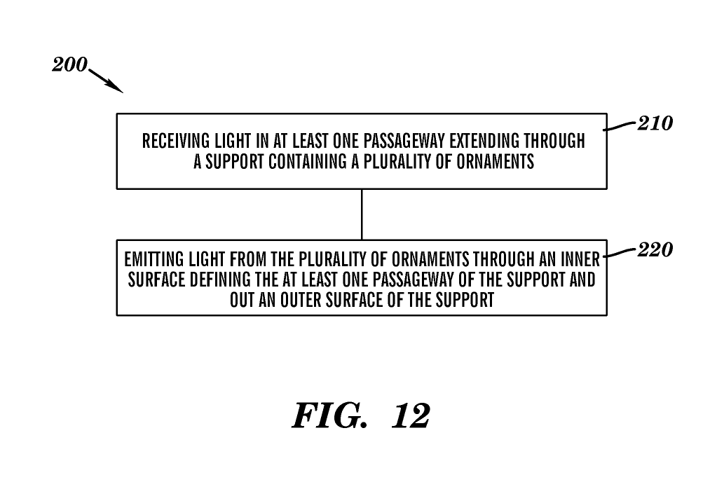

FIG. 12 is a flowchart illustrating a method 200 for providing illumination in accordance with aspects of the present disclosure. Method 200 may include at 210, receiving light in at least one passageway extending through a support containing a plurality of ornaments, and at 220, emitting light from the plurality of ornaments through an inner surface defining the at least one passageway of the support and out an outer surface of the support.

It is to be understood that the above description is intended to be illustrative, and not restrictive. For example, the above-described embodiments and/or aspects thereof may be used in combination with each other. In addition, many modifications may be made to adapt a particular situation or material to the teachings of the various embodiments without departing from their scope.

While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A lighting fixture comprising:
a support having an outer surface and at least one inner surface defining at least a portion of a passageway extending through said support;
a plurality of ornaments disposed inside said passageway; and
at least one of a light source and a receptacle for a light source for emitting light into said passageway and onto some of said plurality of ornaments which emitted light is at least one of refracted and reflected from said plurality of ornaments through said at least one inner surface and out said outer surface of said support.

2. The lighting fixture of claim 1 wherein said first inner surface defines an enclosed passageway extending through said support.

3. The lighting fixture of claim 1 wherein said plurality of ornaments is disposed adjacent to said at least one inner surface, and said passageway includes a hollow cavity in said passageway.

4. The lighting fixture of claim 1 wherein said plurality of ornaments is attached to said at least one inner surface to define said hollow cavity in said passageway.

5. The lighting fixture of claim 4 wherein said plurality of ornaments defines a generally constant layer thickness of ornaments attached to said at least one inner surface of said passageway.

6. The lighting fixture of claim 1 wherein said at least one light source and said receptacle for the light source is operable for emitting light into an end of said at least one passageway.

7. The lighting fixture of claim 1 wherein said support comprises a generally transparent support.

8. The lighting fixture of claim 1 wherein said plurality of ornaments comprises a plurality of crystals.

9. The lighting fixture of claim 1 wherein said plurality of ornaments comprises a plurality of crystals having an average diameter of about 3 millimeters.

10. The lighting fixture of claim 1 wherein said support comprises a planar support.

11. The lighting fixture of claim 1 wherein said support comprises a monolithic support.

12. The lighting fixture of claim 1 wherein said at least one inner surface defining said at least said portion of said passageway comprises a plurality of inner surfaces defining at least a plurality of portions of a plurality of passageways, and said plurality of ornaments being disposed inside said plurality of passageways.

13. The lighting fixture of claim 1 further comprising a frame for supporting a peripheral edge of said support and covering said at least one of said light source and said receptacle for the light source.

14. The lighting fixture of claim 1 wherein said at least one said light source and said receptacle for the light source comprises at least one light emitting diode.

15. A lighting fixture comprising:
a generally transparent support having an outer surface and a plurality of inner surfaces defining a plurality of passageways extending through said support;
a plurality of ornaments disposed inside said plurality of passageways; and
at least one light source and a receptacle for a light source for emitting light into said plurality of spaced-apart passageways and onto some of said plurality of ornaments which emitted light is at least one of refracted and reflected from said plurality of ornaments through said plurality of inner surfaces and out said outer surface.

16. The lighting fixture of claim 15 wherein said plurality of inner surfaces defines enclosed passageways extending through said support.

17. The lighting fixture of claim 16 wherein said plurality of ornaments is disposed adjacent to said inner surfaces, and said passageway includes hollow cavities in said passageways.

18. The lighting fixture of claim 17 wherein said plurality of inner surfaces define a plurality of spaced-apart passageways.

19. The lighting fixture of claim 18 wherein said plurality of ornaments comprise a plurality of crystals.

20. The lighting fixture of claim 19 wherein said plurality of crystals comprises an average diameter of about 3 millimeters.

21. The lighting fixture of claim 20 wherein said support comprises a planar support.

22. The lighting fixture of claim 21 wherein said support comprises a monolithic support.

23. The lighting fixture of claim 22 wherein said plurality of ornaments is attached to said at least one inner surface to define said hollow cavity in said passageway.

24. The lighting fixture of claim 23 wherein said plurality of crystals define a generally constant layer thickness of crystals attached to said inner surfaces of said passageways.

25. The lighting fixture of claim 24 further comprising a frame for supporting a peripheral edge of said support and covering said at least one of said light source and said receptacle for the light source.

26. The lighting fixture of claim 25 wherein said at least one said light source and said receptacle for the light source comprises at least one light emitting diode.

27. A method for providing illumination, the method comprising:
receiving light in at least one passageway extending through a support containing a plurality of ornaments; and
emitting light from the plurality of ornaments through an inner surface defining the at least one passageway of the support and out an outer surface of the support.

28. The method of claim 27 wherein the receiving light comprises receiving light in an enclosed passageway extending through the support.

29. The method of claim 27 wherein said plurality of ornaments is disposed adjacent to said at least one inner surface, and said passageway includes a hollow cavity in said passageway.

30. The method of claim 27 wherein said plurality of ornaments is attached to said at least one inner surface to define said hollow cavity in said passageway.

31. The method of claim 30 wherein said plurality of ornaments defines a generally constant layer thickness of ornaments attached to said at least one inner surface of said passageway.

32. The method of claim 27 wherein the receiving light comprises receiving light into an end of the at least one passageway.

33. The method of claim 27 wherein the support comprises a generally transparent support.

34. The method of claim 27 wherein the plurality of ornaments comprise a plurality of crystals.

35. The method of claim 27 wherein the plurality of ornaments comprise a plurality of crystals having an average diameter of about 3 millimeters.

36. The method of claim 27 wherein the support comprises a planar support.

37. The method of claim 27 wherein the support comprises a monolithic support.

38. The method of claim 27 wherein the receiving light comprises receiving light in a plurality of passageways extending through a support containing the plurality of ornaments.

39. The method of claim 38 further comprising receiving light in a portion of said support disposed between said plurality of passageways.
